(19) United States
(12) Patent Application Publication
(10) Pub. No.: US 2009/0074705 A1
(43) Pub. Date: Mar. 19, 2009

(54) Process for forming metal nanoparticles in polymers

(76) Inventors: Uschi Graham, Lexington, KY (US); Rajesh Khatri, Georgetown, KY (US)

Correspondence Address: JAMES M. FRANCIS, 300 W VINE ST, STOLL KEENON OGDEN PLLC, LEXINGTON, KY, 40507, US

(21) Appl. No.: 12/181,319

(22) Filed: Jul. 28, 2008

Related U.S. Application Data
(60) Provisional application No. 60/952,234, filed on Jul. 26, 2007.

(51) Int. Cl. A01N 59/16; C08K 3/10; F21V 9/04; B01J 31/12

(52) U.S. Cl. 424/78.17; 524/403; 252/587; 502/159

(57) ABSTRACT

A one step process is described for forming metal nanoparticles in polymers at atmospheric pressure and room temperature or with mild heating and stirring. The inventive process includes addition of nanoparticle precursor salts, e.g. HAuCl₄ or AgNO₃ into a “reducing” polymer resin, for example polyurethane resins, derivitized polyurethanes, polyurethane acyrlates and combinations thereof. With stirring, often at room temperature, the salts are rapidly reduced to form metal nanoparticles, usually less than 100 nm in size and often in the size range of 20-40 nm, and even as small 2 nm, depending on the concentration of salt precursor used and the exact polymer composition. The resultant metal nanoparticle-containing polymer resins have a wide range of utility for making coatings and other polymeric materials with properties potentially useful for anti-bacterial use, optical coatings, or catalysts.

### REFERENCE TO RELATED APPLICATIONS

This application claims priority from U.S. Provisional Patent Application Ser. No. 60/952,234 filed Jul. 26, 2007, the entire contents of which is incorporated herein by reference.

### FIELD OF THE INVENTION

The present invention relates generally to in-situ nanoparticle formation and more specifically it relates to a one step process for forming metal nanoparticles in polymers at atmospheric pressure and room temperature or with mild heating and stirring.

### BACKGROUND OF THE INVENTION

Typically, metallic nanoparticles are formed by creating powders made in vapor phase reactions, e.g. from plasmas. Another common technique for forming metallic nanoparticles is to form them in micro-emulsions. Most recently researchers have looked for direct techniques to incorporate silver nanoparticles in polymer coatings, e.g. the work of Joerg Tiller at the University of Freiberg to form silver nanoparticles in derivitized polyethylene glycol via a two step process. Clemson University researchers have mixed powdered silver nanoparticles in polyglycidyl methacrylate to make a coating for textiles. Most recently, researchers at the Pennsylvania State University have made silver bromide nanoparticles in a cationic polymer by a direct synthesis technique, Sen et al., 2006.

The main problem with conventional methods to make metallic nanoparticles in polymers is the cost of the formation process of the particles and the difficulty in dispersing them as nanoparticles in the desired media, particularly polymers, which are viscous. Even with very recent discoveries in making in-situ nanoparticles directly formed in the polymer, the process is likely to be more expensive then the extremely simple process of the present invention. The only process that is at all competitive with the simplicity of the present invention is the work on silver bromide nanoparticles. However silver bromide is a salt not a metal. While these prior processes for making metallic nanoparticles in polymers may be suitable for the particular purpose to which they addressed, they are not as efficient as the present process which has one step and is conducted at atmospheric pressure and room temperature or with simple mild heating and stirring.

In these respects, the one step process for forming metal nanoparticles in polymers according to the present invention substantially departs from the conventional concepts and designs of the prior art, and in so doing provides a process primarily developed for its simplicity and relatively low cost for forming metal nanoparticles in polymers with excellent dispersion and very small size.

### SUMMARY OF THE INVENTION

In view of the foregoing disadvantages inherent in the known types of metallic nanoparticle formation in polymers now present in the prior art, the present invention provides a new one step process for forming metal nanoparticles in polymers at atmospheric pressure and room temperature or with only mild heating and stirring wherein the process can be utilized for creating a polymer resin with metallic nanoparticles of controlled small size and excellent dispersion. This resin can then be used to form polymeric film or composites with a myriad of uses, including coatings.

The general purpose of the present invention, which will be described subsequently in greater detail, is to provide a new one step process for forming metal nanoparticles in polymers that has many of the advantages of the in-situ nanoparticle formation mentioned heretofore and many novel features that result in a simpler method for forming metal nanoparticles in polymers which is not anticipated, rendered obvious, suggested, or even implied by any of the prior art, including in-situ nanoparticle formation, either alone or in any combination thereof.

To attain this, the present invention generally comprises the addition of nanoparticle precursor salts (e.g. HAuCl₄ or AgNO₃, zinc octoate, zinc napthenate, ZnNO₃, silver acetate, zince acetate, and silver napthenate) into a polymer resin that acts to aid reduction of the metal salt to the metallic state, for example polyurethane resins, derivitized polyurethanes, polyurethane acrylates and combinations thereof. Other polar agents of higher molecular weight, e.g. dispersants of molecular weight greater than 10,000 were used to control the size of the nanoparticle and prevent its continuing growth to larger sizes when in liquid solution. These agents can particularly be selected as supplemental reducing agents and, when this is the only objective, smaller molecular weight materials (i.e. mol. wt. less than 10,000) are also effective. With stirring, often at room temperature, the salts are reduced to form nanoparticles, usually less than 100 nm in size and often in the size range of 20-40 nm, and even as small 2 nm, depending on the concentration of salt precursor used and the exact polymer composition. Typically the size distribution within one sample is fairly uniform. Bimodal distribution is also possible in which one set of particles fairly large (e.g. 70 +/−10 nm) and a tight distribution of smaller size nanoparticles is also created in the same sample (e.g. 10 nm +/−2 nm). If only one size particle is formed a very tight size distribution with few occasional large particles (still in nanosize) is expected. The nanoparticle formation is often extremely rapid, within minutes or less than an hour following mixing.

In the foregoing, it has been outlined, rather broadly, the more important features of the invention in order that the detailed description thereof may be better understood, and in order that the present contribution to the art may be better appreciated by those skilled in the art. There are additional features of the invention that will be described hereinafter.

It is to be understood that the invention is not limited in its application to the details of construction and to the arrangements of the components set forth in the following description or described in the examples. The invention is capable of additional embodiments and of being practiced and carried out in various ways known or knowable to those skilled in the art. Also, it is to be understood that the phraseology and terminology employed herein are for the purpose of the description and should not be regarded as limiting.

A primary object of the present invention is to provide a one step process for forming metal nanoparticles in polymers that will overcome the shortcomings of the prior art devices.

An object of the present invention is to provide a one step process for forming metal nanoparticles in polymers at atmospheric pressure and room temperature or with mild heating and stirring.

Another object is to provide a one step process for forming metal nanoparticles in polymers which are coatings resins. The metal nanoparticles formed are silver or gold or hybrids (combinations) of silver and gold. It is further contemplated that other metal salts will form metal nanoparticles when combined with the appropriate polymer resin and reducing agents and that such are known or knowable to those skilled in the art without undue experimentation.

Another object is to provide a one step process for forming metal nanoparticles in polymers for making a coating that has properties conveyed by the nanoparticles, for example, antibacterial action from silver nanoparticles, light absorption from silver and/or gold nanoparticles, catalytic action from silver or gold nanoparticles or combinations thereof.

Another object is to provide a one step process for forming metal nanoparticles in polymers in which the metal nanoparticles can be stabilized at a certain controlled size by adding dispersants either in the nanoparticle precursor salt—resin liquid mixture that forms the nanoparticles or in the coating resin itself. It is anticipated that one skilled in the art will appreciate that the following disclosures are not limiting to the disclosed dispersants/reducing agents, and that equivalent additives are known or knowable to those skilled in the art and can be paired with appropriate nanoparticle precursors and polymer resins without undue experimentation.

Another object is to provide a nanoparticle precursor salt—resin concentrate that can be added to a large amount of resin and form nanoparticles either immediately while still liquid or only after the resin is cured as a coating, depending on the application. The immediate formation or not is controlled by controlling the reducing environment; i.e. chemistry of the coating, chemistry of dispersing agents and supplemental reducing agents if added.

Another object for some applications is to not use a concentrate but rather to add the precursor salt, dispersant, and supplemental reducing agent (if needed) directly to the resin batch.

Another object is to provide a one step process for forming metal nanoparticles in polymers in which the metal nanoparticles are combined with trace elements such as rhodium, cobalt, nickel, etc.

Another object is to provide a one step process for forming metal nanoparticles in polymers in which the polymers aid the reduction of the metal salt precursor materials to form metallic nanoparticles and in which the process can be carried out at room temperature and pressure or with only mild temperature and stirring.

Other objects and advantages of the present invention will become obvious to readers and those skilled in the art and it is intended that these objects and advantages are within the scope of the present invention.

To the accomplishment of the above and related objects, this invention may be embodied in the form illustrated in the accompanying examples, attention being called to the fact, however, that the examples are illustrative only, and that changes may be made in the specific construction illustrated.

### BRIEF DESCRIPTION OF THE DRAWINGS

FIG. 1 is a surface plot of the color response plotted against the percentage of gold and percentage of nanoparticle precursor material.

### DETAILED DESCRIPTION OF THE INVENTION

Turning now descriptively to the process, the described examples illustrate a one step process for forming metal nanoparticles in polymers, which comprises the addition of metal salts, either in solution or as solids, e.g. HAuCl₄, AgNO₃, zinc nitrate into a reducing polymer resin, for example polyurethane resins, derivitized polyurethanes, polyurethane acyrlates and combinations thereof. With stirring, often at room temperature, the salts are reduced to form nanoparticles, usually less than 100 nm in size and often in the size range of 20-40 nm, and even as small 2 nm, depending on the concentration of salt precursor used and the exact polymer composition. The mixing described herein was mechanical and the force required is related to the viscosity of the polymer resin and the concentration of the nanoparticle precursor.

Not all metal salts are desirable or useful precursors. The salts must be selected to be soluble in the reducing polymer or in a solution of the reducing polymer. For example, polyurethane resin systems are available in a variety of forms, namely, two part resin systems which are non-aqueous and are combined to achieve the final cross-linked polyurethane coating, or as fully reacted latexes of already cross-linked polyurethanes in water, or as fully reacted polyurethane polymer in solvent. For aqueous polymers salts are selected to be soluble in water, for example, HAuCl₄, AgNO₃ and they can be added as aqueous solutions at low concentration. For the non-aqueous polymers we have found that the salts have surprisingly good ability to dissolve in the base resin of the two-part polyurethane type resin system.

The precursors are selected to be easily dissolved in the polymer resin matrix, which should act to aid reduction of the metal salt to form metallic nanoparticles. It will be obvious to those skilled in the art that other resins than polyurethane-type resins may be used as the “reducing” polymer, e.g polyvinyl alcohol, etc. Also other reducing agents such as borax (sodium borohydrate), and solvents, e.g. ethyl acetate may also be added to the polymer to speed the time of reaction or intensify the color formed. The polymer simply has to act to cause an oxidation-reduction reaction with the precursor salt. For example, polyethylene or polypropylene glycols and other polymers with alcohol groups would be expected to be good candidates as “reducing” polymers. For metal salts with lower electrode potential a polymer with greater electron donating potential should be used. Further, for salts of multivalent metals particles such as oxides are more likely to be formed instead of metals and these may also have useful properties such as being colored or providing UV protection.

The metal nanoparticles in polymer compositions made by the present invention have a number of potentially useful properties. The nanosilver in aqueous polyurethane latex compositions may have anti-bacterial properties, or when prepared at adequate silver concentration may be used as glazes on glass to absorb and reflect infrared wavelength light. Similiarly the nanogold particles in polyurethane or the hybrid nanosilver/nanogolds can be used as solar glazes. The nanosilver particles in polymer may also be used as coatings for fabrics to resist bacteria. Any of the metal nanoparticle/polymer compositions may have utility as coatings for specific catalyst applications.

As to a further discussion of the manner of usage and operation of the present invention, the same should be apparent from the above description. Accordingly, no further discussion relating to the manner of usage and operation will be provided.

With respect to the above description then, it is to be realized that the optimum recipe for the parts of the invention, to include variations in metallic salt concentration, type, solubility parameters, form, and whether it is pre-dissolved in water or some other solvent, as well as the selection of the “reducing” polymer, and supplemental agents such as dispersant and/or reducing aid, are deemed readily apparent and obvious to one skilled in the art, now that the surprising capacity for rapid formation of nanoparticles has been revealed, and all equivalent relationships to those illustrated in the examples and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and utility shown and described, and accordingly, all suitable modifications and equivalents may be resorted to, falling within the scope of the invention.

### DESCRIPTION OF THE EXAMPLES

Various other objects, features and attendant advantages of the present invention will become fully appreciated as the same becomes better understood when considered in conjunction with the accompanying examples for the formation of gold, silver, and zinc oxide nanoparticles in aqueous polyurethane or polyvinyl alcohol based coatings. The coating materials utilized in the following examples are SEI CPT-303, polyvinyl alcohol (PVA), Witcobond 290H, and Witcobond A100. The precursor materials utilized in the following examples are HAuCl₄ neat or in H₂O, ethanol, acetone; AgNO₃ neat or in acetone, H₂O, zinc acetate in H₂O. The reducing agents available for use in the following examples are borax, PVA, and an aqueous acrylate emulsion polymer such as CARBOPOL EP-2.

### Example 1

A solution of HAuCl₄ at concentrations 0.001 or 0.002 or 0.005 molar in deionized distilled is added dropwise to a water-based, fully reacted polyurethane latex, e.g. Witcobond 290H at room temperature and pressure to a total concentration of 1 part gold salt solution to 10 parts of aqueous polyurethane. Within 15 minutes the solution turns color, ranging from pink to blue depending on the exact concentrations of reactants. The color is derived from the formation of gold nanoparticles, confirmed by transmission electron microscopy. The red color is derived from particles are in the size range of around 5 nm to under 20 nm while blue color derives from slightly larger particles, from 20 nm up to 75 nm. While not wishing to be bound to any exact chemical mechanism, it is believed that the polyurethane latex serves to reduce the gold salt to form the gold nanoparticles. The derived blue resin was spread on a glass slide and dried to a transparent dark purple coating.

### Example 2

A gold salt powder, HAuCl₄, was dissolved directly into a water based, self-crosslinking, urethane type resin which contains 5-10% of ethylene glycol monobutyl ether, itself a reducing agent toward the gold salt. The coating resin, CPT 303 is made by SEI Chemical. The gold concentration in the resin was varied from 0.00017 to 0.00085 Molar solution. Dissolution was effected with continuous stirring at room temperature and atmospheric pressure for 5-10 hours, by which time a solution with colors ranging from light to dark purple was formed. The resulting solutions were spread on glass slides to form completely transparent purple colored coatings containing gold nanoparticles.

### Example 3

A solution of 0.01 g of HAuCl₄ in 1 ml of ethanol was mixed with SEI Chemicals CPT 303 and stirred continuously for 5-10 hours at room temperature and pressure. The resulting solution was a very dark blue in color. When spread on a glass slide it resulted in a completely transparent dark blue coating due to gold nanoparticles.

### Example 4

An aqueous solution of 0.02 g of silver nitrate in 0.5 ml of water was dissolved into SEI Chemical's CPT 303 with continuous stirring for 10-15 hours at room temperature and atmospheric pressure. The resulting solution had a brown color which when spread on a glass slide resulted in a completely transparent brown coating due to silver nanoparticles.

### Example 5

An aqueous solution of silver nitrate was prepared by adding 0.01 to 0.05 g silver nitrate to 1 ml of water. The resulting solutions were mixed at 1 g silver nitrate solution to 5 g of Witcobond 290H water based polyurethane and stirred at room temperature and atmospheric pressure for 10 to 15 hours, which created very dark yellowish brown solutions. These solutions were further diluted with Witcobond 290H and spread on glass slides. They made completely transparent coating ranging from pale yellow to bright yellow. The silver nanoparticles are in the size range of 5 to 10 nm.

### Example 6

The gold salt powder of Example 2 was dissolved directly into Witcobond 290H with minimal stirring at room temperature and atmospheric pressure and resulted in an immediate reddish colored resin solution. When spread on a glass slide it made a light red transparent coating. The gold nanoparticles are in the size range of 5 to 10 nm.

### Example 7

When the solution of example 6 was mixed with the solution of example 5 upon which a peach colored solution containing both silver and gold nanoparticles. The gold nanoparticles and the gold nanoparticles are in the 5-10 nm size range and continue to be dispersed as individual nanoparticles. Any dilution ratio of the two stock solutions from examples 5 and 6 is possible.

### Example 8

0.5 ml of 4 wt % aqueous solution of HAuCl₄ was mixed with 3 ml of Witcobond A-100 aqueous polyurethane dispersion which resulted in deep purple coating solution at room temperature over few hours.

### Example 9

0.5 ml of 4 wt % aqueous solution of HAuCl₄ was mixed with 3 ml of Witcobond 290H formulated with isopropyl alcohol which resulted in dark purple coating solution in 20 minutes at room temperature.

The formation of gold, silver and zinc oxide nanoparticles in nonaqueous polyurethane based coatings and olefin copolymers (soft coating or liquid) is described in the following examples. The coating materials utilized in the following examples are PPG DC3000, DC3085 (two part), PPG SRA 93, MINWAX in aliphatic solvent, and olefin copolymer. The precursor materials utilized in the following examples are HAuCl4 neat or 4% in xylene with Ircosperse; AgNO₃ in progress; zinc octoate in xylene (zinc octoate has some diethyleneglycol monobutyl ether, cross organics). The reducing agents utilized (if needed) in the following examples are Ircosperse 2174 (50% w/w in min spirits or xylene) which acts as dispersant and improves reduction; trioctylamine neat or 50% w/w in solvent mineral spirits; 1,2,2,6,6 PMP (pentamethylpiperidine). Cloisite Na+clay with acidic sites and silicas are also anticipated to facilitate reduction.

### Example 10

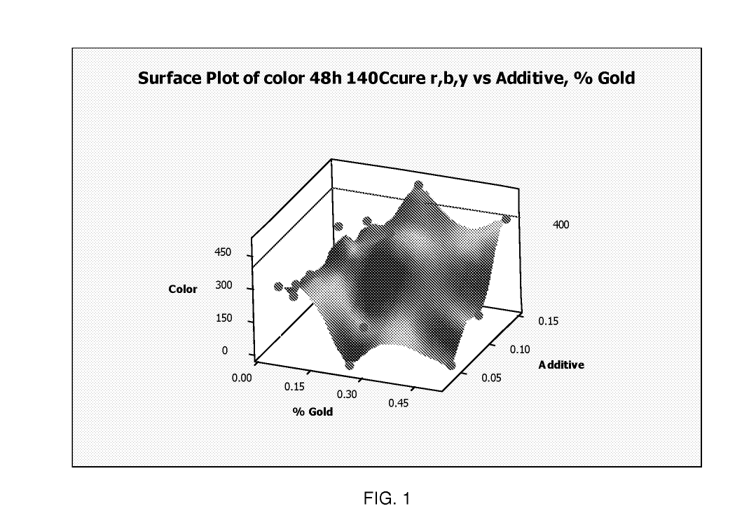

A series of solutions was prepared using the gold precursor salt HAuCl₄ at concentrations of 0.001% to 0.010% wt/wt of salt in polymer resin in a high temperature cure polyurethane coating. A dispersant was used to control particle size, an oil soluble succinimide, LUBRIZOL 2153. The color of the cured coating (resulting from gold nanoparticles) was evaluated after the liquid polymer resin and precursor mixture was stored for various time periods, either when curing the coating at room temperature or at 140° C. (140° C. is the recommended cure temperature for coating of example 10 and is not utilized as a limiting parameter for other polymer resins). It was determined that there was an optimum range of dispersant to gold precursor concentration (approximately, specific to this urethane resin, to achieve the same coating color independent of storage of the precursor salt-resin-dispersant mixture as shown below in the figure. The color was rated for red:blue:yellow on a scale of 1-5 for each color with 5 being the deepest color. The color in FIG. 1 is shown as 400 when it is rated as true deep red with no blue or yellow.

### Example 11

0.5 ml of zinc octoate was mixed with 3 ml of high temperature cure (140°) aqueous polyurethane coating which yielded yellow colored coatings with ZnO upon curing.

### Example 12

1 ml of 0.0033 wt % HAuCl₄ solution in xylene was mixed with 15 ml of commercial Minwax which turned red in color due to gold nanoparticles over period of weeks.

### Example 13

0.38 g of 0.0033 wt % HAuCl₄ solution in xylene was mixed with 2 g of 7 wt % Paratone 8910 OCP in mineral spirits. Coating films from above formulation was bought in contact with pure trioctyl amine which changed the color of films to blue upon formation of nanoparticles.

### Example 14

1 ml of 0.0066 wt % HAuCl4 solution in xylene was mixed with 10 drops of PMP and stirred at room temperature which resulted in dark purple color over period of 24 hours.

### Example 15

3 ml 7 wt % olefin copolymer (OCP) Paratone 8900 in mineral spirits was mixed with 0.5 ml of 50 wt % Ircosperse 2174 in mineral spirits and 0.5 ml of 0.0066 wt % HAuCl₄ solution in xylene to which 0.075 g Cloisite Na+clay was added which changed the color to blue upon formation of gold nanoparticles at room temperature.

What is claimed is:

1. The method of forming and dispersing a metal nanoparticle in polymers comprising: providing at least one nanoparticle precursor salt; providing a polymer resin capable of reducing said metal salt to its metallic state; mixing said at least one nanoparticle precursor salt into said polymer resin, wherein said mixing can occur at substantially 1 atm.

2. The method of claim 1, wherein said mixing and reduction occur at pressures in excess of 1 atm.

3. The method of claim 1, wherein said polymer resin has a viscosity which does not inhibit said nanoparticle precursor salt to be mixed into said polymer resin.

4. The method of claim 1, wherein said nanoparticle precursor salt is selected from the group consisting of HAuCl₄, AgNO₃, silver acetate, zince acetate, zinc octoate, zinc napthenate, ZnNO₃, and silver napthenate.

5. The method of claim 1, wherein said polymer resin can be utilized as a curable coating.

6. The method of claim 1, wherein said curable coating can be cured by heat.

7. The method of claim 1, where said curable coating can be cured by radiation.

8. The method of claim 5, wherein said polymer resin is selected from the group consisting of polyurethane resins, derivitized polyurethanes, polyurethane acrylates, and combinations of polyurethane resins, derivitized polyurethanes, and polyurethane acrylates.

9. The method of claim 1, further comprising the step of adding at least one dispersant to the mixture of claim 1, wherein said dispersant is capable of acting to control the size of said metal nanoparticles.

10. The method of claim 9, wherein said dispersant has a molecular weight of at least approximately 10,000.

11. The method of claim 1, further comprising the step of adding at least one dispersant to the mixture of claim 1; wherein said dispersant is capable of acting as a supplemental reducing agent.

12. The method of claim 11, wherein said dispersant has a molecular weight less than approximately 10,000.

13. The method of claim 1, wherein the size of said metal nanoparticle is controlled at least in part by the concentration of said nanoparticle precursor salt.

14. The method of claim 1, wherein the size of said metal nanoparticle is controlled at least in part by said polymer resin utilized in the mixture of claim 1.

15. The method of claim 1, wherein the size of said metal nanoparticle is controlled at least in part by the concentration of said nanoparticle precursor salt utilized in the mixture of claim 1.

16. The method of claim 1, wherein the size of said metal nanoparticle is controlled at least in part by the relationship between the concentration of said nanoparticle precursor salt and said polymer resin utilized in the mixture of claim 1.

17. The method of claim 1, wherein the rate of reduction of said nanoparticle precursors to said metal nanoparticles is controlled at least in part by the extent to which said mixture of claim 1 facilitates the reduction of said nanoparticle precursor.

18. The method of claim 1, wherein said nanoparticle precursor is added to said polymer resin in a concentration of between 10% and 25% by mass.

19. The method of claim 1, wherein said nanoparticle precursor is added to said polymer resin in a concentration of between 0.0005 and 10% by mass.

20. The method of claim 1, wherein said nanoparticle precursor is added to said polymer resin in a concentration of between 0.001 and 6% by mass.

21. The method of claim 1, wherein said nanoparticle precursor comprising HAuCl₄ is added to said polymer resin between 0.01 and 5% by mass.

22. The method of claim 1, wherein said formed nanoparticles are between approximately 2 nm and 100 nm in size.

23. The method of claim 1, wherein said metal nanoparticles formed from the method described in claim 1 are combined with trace elements.

24. The method of claim 23, wherein said trace elements of claim 23 are selected from the group consisting of rhodium, cobalt, and nickel.

25. A metal nanoparticle composition as created by the method described in claim 1, wherein said nanoparticle composition comprising nanosilver in an aqueous polyurethane latex resin exhibits anti-bacterial properties.

26. The method of treating a textile with the composition described in claim 25 for the purpose of inhibiting the growth of bacteria.

27. A metal nanoparticle composition as created by the method described in claim 1, wherein a coating created from a nanoparticle composition comprising nanosilver or nanogold or combinations thereof in polyurethane is utilized as a solar glaze on glass to filter infrared light.

28. A metal nanoparticle composition as created by the method described in claim 1, wherein a coating created from a nanoparticle composition comprising ZnO thereof in polyurethane is utilized as a solar glaze on glass to filter infrared light.

29. A metal nanoparticle composition as created by the method described in claim 1, wherein a coating created from a nanoparticle composition of zinc octoate mixed into a polymer resin of high temperature cure aqueous polyurethane imparts UV filtering when utilized as a coating.

30. A metal nanoparticle composition as created by the method described in claim 1, wherein a coating created from a nanoparticle composition is utilized as a catalyst.
